(19) United States
(12) Patent Application Publication
(10) Pub. No.: US 2017/0076327 A1
(43) Pub. Date: Mar. 16, 2017

(54) METHOD AND SYSTEM FOR DYNAMICALLY PROVIDING ADVERTISEMENTS FOR COMPARISON

(71) Applicant: Yahoo! Inc., Sunnyvale, CA (US)

(72) Inventors: Frank Filippini, Redwood City, CA (US); Jorge Angarita, Los Angeles, CA (US); Wayne Greenwood, La Honda, CA (US); Dan Parent, Santa Monica, CA (US); Lisa Giaffo, Pasadena, CA (US); Erin P. Sheedy-Owen, La Canada, CA (US)

(73) Assignee: YAHOO! INC., Sunnyvale, CA (US)

(21) Appl. No.: 14/851,214

(22) Filed: Sep. 11, 2015

(51) Int. Cl. G06Q 30/02; G06F 17/30

(52) U.S. Cl. CPC G06Q 30/0256; G06F 17/30867; G06F 17/30598; G06Q 30/0261; G06Q 30/0275; G06Q 30/0277

(57) ABSTRACT

The present teaching relates to providing dynamic advertisements for comparison. In one example, a request is received for selecting advertisement. The request incorporates a query. The query is analyzed to determine a category of product and determine one or more attributes of the category of product based on the query. At least one advertisement associated with the category of product is selected based on the one or more attributes and the request. An instruction on presentation of the at least one advertisement is generated in accordance with the one or more attributes. Information related to the instruction and the at least one advertisement is sent as a response to the request.

### BACKGROUND

1. Technical Field

The present teaching relates to methods, systems, and programming for advertisements. Particularly, the present teaching is directed to methods, systems, and programming for providing dynamic advertisements for comparison.

2. Discussion of Technical Background

The advancement in the Internet has made it possible to provide advertisements to users through the Internet. A query from a user can be leveraged for selecting relevant advertisements for comparison.

When the advertisements are presented for comparison, most existing techniques try to provide fixed attributes associated with the advertisements. For example, as shown in FIG. 4, a same list of advertisements 410 is presented in response to two different queries “SUVs” 402 and “Performance SUVs” 404. Without considering interests and needs of the users entering the two queries, FIG. 4 always presents the same attributes of photo, title, prices and fuel efficiency associated with SUVs. This kind of advertisement comparison may miss the user's search intent and cannot attract the user to engage in the provided advertisements.

Therefore, there is a need to develop techniques to provide advertisements for comparison to overcome the above drawbacks.

### SUMMARY

The present teaching relates to methods, systems, and programming for advertisements. Particularly, the present teaching is directed to methods, systems, and programming for providing dynamic advertisements for comparison.

In one example, a method, implemented on a machine having at least one processor, storage, and a communication platform capable of connecting to a network for providing an advertisement is disclosed. A request is received for selecting advertisement. The request incorporates a query. The query is analyzed to determine a category of product and determine one or more attributes of the category of product based on the query. At least one advertisement associated with the category of product is selected based on the one or more attributes and the request. An instruction on presentation of the at least one advertisement is generated in accordance with the one or more attributes. Information related to the instruction and the at least one advertisement is sent as a response to the request.

In a different example, a system for providing an advertisement is disclosed, which includes an ad request receiver, an ad request analyzer, an ad selector, an ad presentation controller, and an ad transmitter. The ad request receiver is configured for receiving a request for selecting advertisement. The request incorporates a query. The ad request analyzer is configured for analyzing the query to determine a category of product and determine one or more attributes of the category of product based on the query. The ad selector is configured for selecting at least one advertisement associated with the category of product based on the one or more attributes and the request. The ad presentation controller is configured for generating an instruction on presentation of the at least one advertisement in accordance with the one or more attributes. The ad transmitter is configured for sending information related to the instruction and the at least one advertisement as a response to the request.

Other concepts relate to software for implementing the present teaching on providing dynamic advertisements for comparison. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable, non-transitory and tangible medium having data recorded thereon for providing an advertisement is disclosed. The medium, when read by the machine, causes the machine to perform a series of steps, including: receiving a request for selecting advertisement, wherein the request incorporates a query; analyzing the query to determine a category of product and determine one or more attributes of the category of product based on the query; selecting at least one advertisement associated with the category of product based on the one or more attributes and the request; generating an instruction on presentation of the at least one advertisement in accordance with the one or more attributes; and sending information related to the instruction and the at least one advertisement as a response to the request.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a high level depiction of an exemplary networked environment for selecting and providing advertisement, according to an embodiment of the present teaching;

FIG. 2 is a high level depiction of another exemplary networked environment for selecting and providing advertisement, according to an embodiment of the present teaching;

FIG. 3 illustrates search result pages displayed on different types of user devices, according to an embodiment of the present teaching;

FIG. 4 illustrates a comparison of advertisements, according to prior art;

FIG. 5 illustrates a comparison of advertisements relevant to a query, according to an embodiment of the present teaching;

FIG. 6 illustrates a comparison of advertisements relevant to another query, according to an embodiment of the present teaching;

FIG. 7 illustrates a comparison of advertisements in an expanded view, according to an embodiment of the present teaching;

FIG. 8 illustrates a comparison of advertisements relevant to a different user query, according to an embodiment of the present teaching;

FIG. 9 illustrates an exemplary diagram of an intelligent ad selection platform, according to an embodiment of the present teaching;

FIG. 10 is a flowchart of an exemplary process performed by an intelligent ad selection platform, according to an embodiment of the present teaching;

FIG. 11 illustrates an exemplary diagram of an ad selector, according to an embodiment of the present teaching;

FIG. 12 is a flowchart of an exemplary process performed by an ad selector, according to an embodiment of the present teaching;

FIG. 13 illustrates an exemplary diagram of an ad presentation controller, according to an embodiment of the present teaching;

FIG. 14 is a flowchart of an exemplary process performed by an ad presentation controller, according to an embodiment of the present teaching;

FIG. 15 illustrates relationships in form of tables among data stored in ad databases, according to an embodiment of the present teaching;

FIG. 16 depicts the architecture of a mobile device which can be used to implement a specialized system incorporating the present teaching; and

FIG. 17 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of providing dynamic advertisements for comparison, realized as a specialized and networked system by utilizing one or more computing devices (e.g., mobile phone, personal computer, etc.) and network communications (wired or wireless). The method and system as disclosed herein aim at providing dynamic advertisements for comparison in an effective and efficient manner.

One of the goals of advertisements is to sell a product and/or a service to users. A user may submit a query to search for products that the user has interest in. Based on the query, a plurality of advertisements relevant to the products can be presented together to the user for a comparison. Depending on the user's need, the user may want to compare different attributes of the products. For example, among users who want to buy smartphones, some user may want to compare screen sizes of the smartphones; some user may want to compare battery life of the smartphones; some user may want to compare storage sizes of the smartphones; and some user may want to compare prices of the smartphones. Therefore, the advertisements presented to a user should not only include products relevant to the query, but also include attributes or features of the products such that the user can compare the attributes to immediately determine a product that the user is most interested in.

Disclosed herein are methods and systems for providing advertisements to users for comparison based on the users' interests. No one can know users' interests better than the users themselves. A query submitted by a user can represent the user's interest at that time. The system disclosed herein can analyze the query to determine a category of products (e.g. smartphone) and determine attributes associated with the category based on the query. The analysis of the query may include parsing the query and/or converting the query to a predetermined query to remove ambiguity of the query. Based on the category and attributes, the system can select corresponding advertisements for presentation to the user with the attributes listed for comparison. For example, if the query is “large smartphone”, the category is smartphone and the attributes may include screen size and smartphone dimension, based on which some advertisements about smartphones can be selected and presented to the user for comparison of the screen sizes and dimensions of the smartphones. In this example, the system herein may select advertisements of smartphones that are ranked highest in terms of screen sizes in the market. When there are many smartphones having similar sizes at the top of the ranking, at least one smartphone can be selected based on a process of bidding performed among advertisers of the smartphones.

In another example, if the query is “fast smartphone”, the category is still smartphone but the attributes may include processor speed and memory size, based on which some advertisements about smartphones can be selected and presented to the user for comparison of the processor speeds and memory sizes of the smartphones. Thus, the attributes of the products can dynamically change according the query even if a same category of products is determined for the query.

According to one embodiment, even if the same category and the same attributes are determined based on two queries, the system disclosed herein may present advertisements with the attributes listed in different orders. For example, in response to a query “best smartphone,” the system may provide attributes of user rating and price, where user rating is presented before the price when the attributes are presented to the user for comparison. In contrast, in response to a query “low-cost smartphone,” the system may provide attributes of user rating and price, where price is presented before the user rating when the attributes are presented to the user for comparison.

The system disclosed in the present teaching may also determine a user's interest based on the user's demographic information, location information, device information, or behavior information online. For example, if the user is female, after receiving a query “large smartphone” from the user, the system can select advertisements about smartphones with large screen size and a color of pink or red to be presented to the user for comparison. For example, if the user is detected to be located in San Jose, Calif., after receiving the query “large smartphone” from the user, the system can select advertisements about large screen smartphones that are being sold in local stores of San Jose. In another example, if the user is detected to use a smartphone to submit the query “large smartphone,” the system can select advertisements about large screen smartphones and present the advertisements in a carousel style including an arrow, such that when the user clicks the arrow, more advertisements are presented on the smartphone's screen to replace the previously presented advertisements. In a different example, the system can collect advertisements clicked by a user from different platforms (Mobile Phone, Tablet, PC, etc.) within a time period. Based on the previous clicking or viewing behaviors, the system can determine the user's interest about a smartphone even if the interest is not explicitly described in the query. For example, if the user has viewed many web pages about smartphones with long battery life, after receiving a query “good smartphone” from the user, the system can select advertisements about smartphones with long battery life to be presented to the user for comparison.

In addition to the attributes of the products, the advertisements presented to a user may also include one or more annotations for the user to better understand the products. The system can determine the annotations based on the user's location, device, demographic information or behavior information. For example, the annotations may include: a brand logo associated with a product in the category determined based on the query; a hyperlink directed to a social network including information about a product in the category; information about sales, discounts, or coupons related to a product in the category; a link directed to a video describing a product in the category; an entry form for a user to enter location information; an icon, once selected by the user, connects the user to a website of a local dealer or a local store; an icon, once selected by the user, activates a phone call to a local dealer or a local store for the user; an icon, once selected by the user, activates presentation of more advertisements associated with the category of product to replace the at least one advertisement; and a link directed to a web page including a plurality of advertisements associated with the category of product, wherein the web page includes one or more metrics related to the plurality of advertisements for the user to select, sort or filter the advertisements.

The terms “ad” and “advertisement” maybe used interchangeably herein. The terms “ads” and “advertisements” maybe used interchangeably herein.

Additional novel features will be set forth in part in the description which follows, and in part will become apparent to those skilled in the art upon examination of the following and the accompanying drawings or may be learned by production or operation of the examples. The novel features of the present teachings may be realized and attained by practice or use of various aspects of the methodologies, instrumentalities and combinations set forth in the detailed examples discussed below.

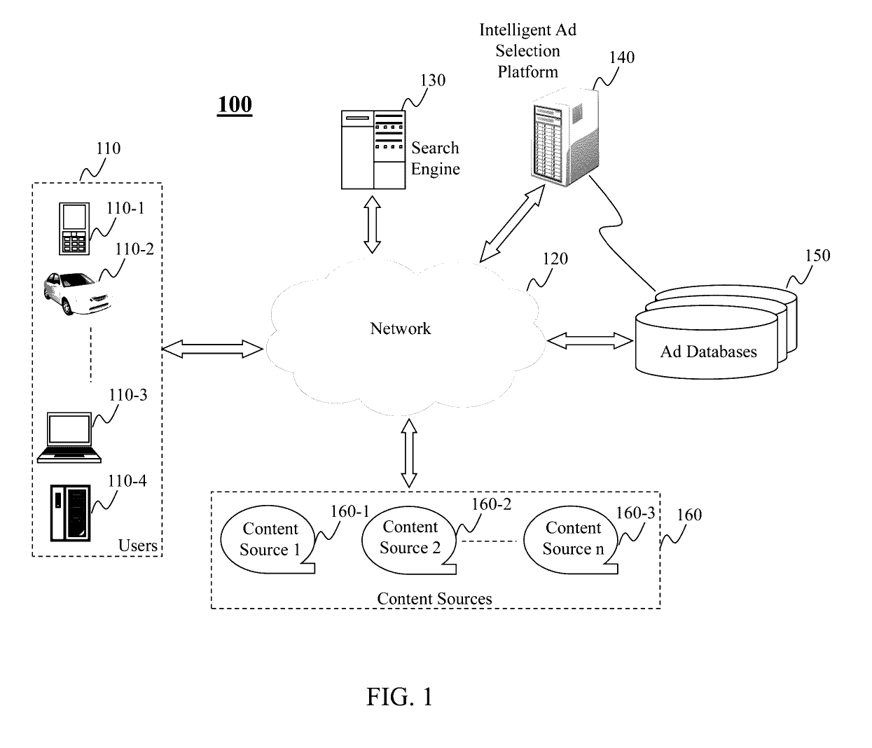

FIG. 1 is a high level depiction of an exemplary networked environment 100 for providing advertisements for comparison, according to an embodiment of the present teaching. In FIG. 1, the exemplary networked environment 100 includes one or more users 110, a network 120, a search engine 130, an intelligent ad selection platform 140, one or more ad databases 150, and content sources 160. The network 120 may be a single network or a combination of different networks. For example, the network 120 may be a local area network (LAN), a wide area network (WAN), a public network, a private network, a proprietary network, a Public Telephone Switched Network (PSTN), the Internet, a wireless network, a virtual network, or any combination thereof. In an example of Internet advertising, the network 120 may be an online advertising network or ad network through which a company connects advertisers to web sites that want to host advertisements.

Users 110 may be of different types such as users connected to the network 120 via desktop computers 110-4, laptop computers 110-3, a built-in device in a motor vehicle 110-2, or a mobile device 110-1. In one embodiment, users 110 may be connected to the network 120 and able to interact with the search engine 130 and the intelligent ad selection platform 140 through wired or wireless technologies and related operating systems implemented within user-wearable devices (e.g., glasses, wrist watch, etc.). A user, e.g., the user 110-1, may send a request for content and/or advertisements related to a product to the search engine 130, via the network 120, and receive content and/or advertisements from the search engine 130 through the network 120.

Search engine 130 may be provided by a service provider that corresponds to an entity, an individual, a firm, or an organization, such as a television station, a newspaper issuer, a web page host, an online service provider, or a game server. The service provider may be an organization such as USPTO.gov, a content provider such as CNN.com and Yahoo.com, or a content-feed source such as tweeter or blogs. In one embodiment, the service provider includes entities that develop, support and/or provide online content via mobile applications (e.g., installed on smartphones, tablet devices, etc.).

Referring to the above example, the search engine 130 may search for content from the content sources 160 based on a request from a user. The request may incorporate a query. A content source may correspond to an entity where the content was originally generated and/or stored. The content sources 160 in the exemplary networked environment 100 include multiple content sources 160-1, 160-2 . . . 160-3.

When content is sent to the user 110-1, one or more advertising opportunities may be available for one or more advertisements to be presented with the content to the user 110-1, on a same web page, via a same application, or in a same user session. For an available advertising opportunity, the search engine may send a request to the intelligent ad selection platform 140 for selecting advertisements based on the query.

The intelligent ad selection platform 140 may select and provide advertisements relevant to the query for the user's comparison. After receiving a request for advertisement from the search engine 130, the intelligent ad selection platform 140 may identify the user to whom the advertisement will be presented and retrieve a user profile created for the user. The intelligent ad selection platform 140 may select one or more advertisements based on the user profile and/or the query incorporated in the request. The user profile may include information about the user's long term preferences regarding advertisements based on the user's device, the user's location, the user's demographic information, the user's behavior information, delivery time, ad category, ad position, etc. The user profile may be created and updated based on the user's previously clicked advertisements and explicit input regarding the user's interest of advertisements. The intelligent ad selection platform 140 may analyze the query to determine the user's short term interest, based on which the intelligent ad selection platform 140 can determine a category of product and attributes associated with the category. The intelligent ad selection platform 140 can then select advertisements from the ad databases 150 based on the determined category and the attributes. The ad databases 150 store different advertisements associated with different categories and different attributes. The intelligent ad selection platform 140 may send the advertisements and an instruction on presentation of the selected advertisements to the search engine 130 or directly to the user for comparison.

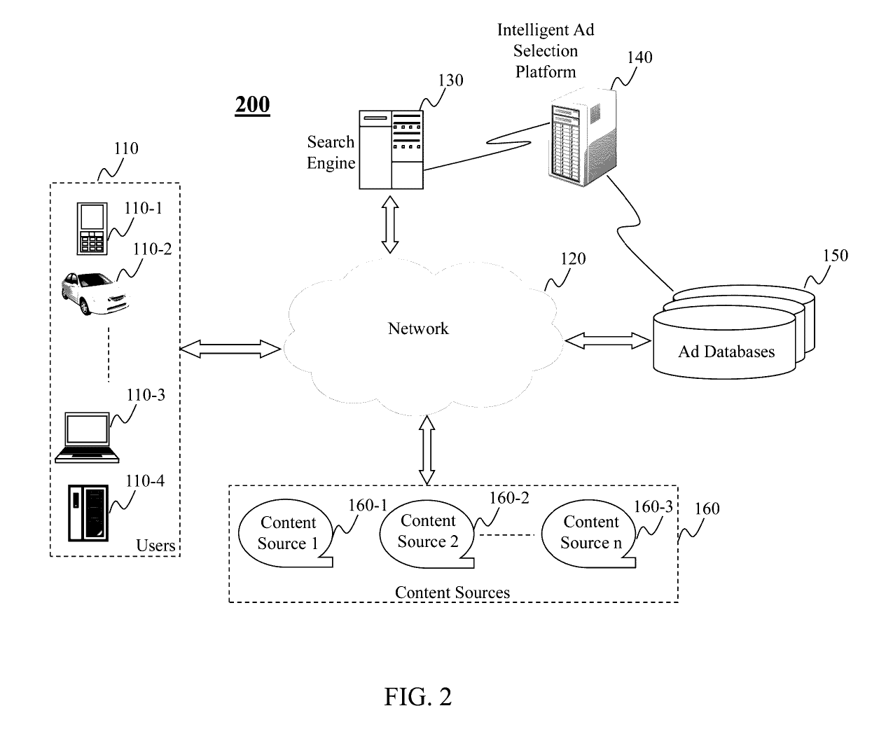

FIG. 2 is a high level depiction of another exemplary networked environment 200 for providing advertisements for comparison, according to an embodiment of the present teaching. The exemplary networked environment 200 in this embodiment is similar to the exemplary networked environment 100 in FIG. 1, except that the intelligent ad selection platform 140 serves as a backend system for the search engine 130.

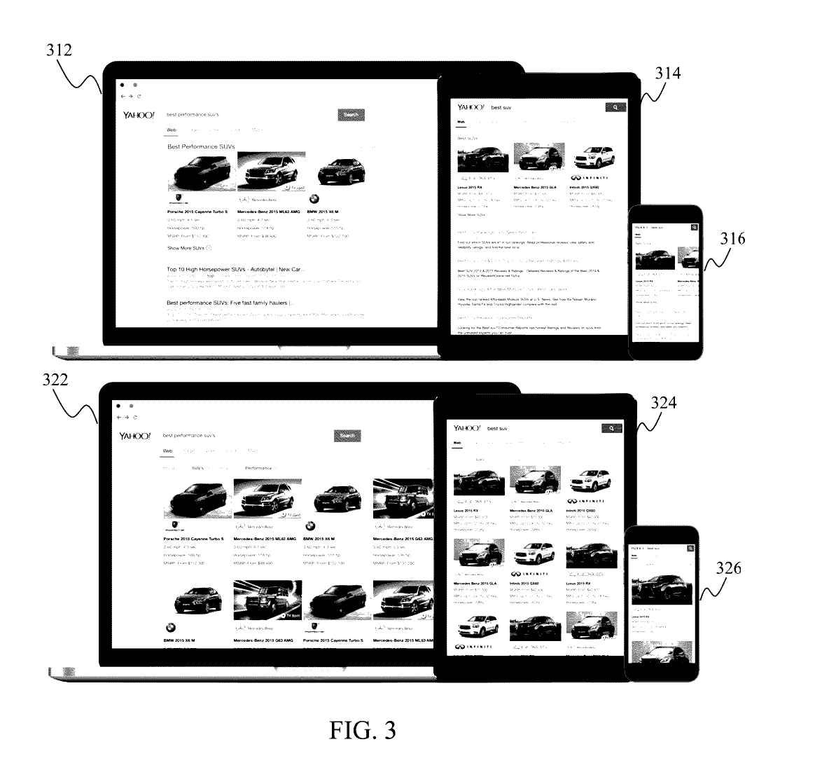

FIG. 3 illustrates search result pages displayed on different types of user devices, according to an embodiment of the present teaching. As shown in FIG. 3, the advertisements for comparison can be presented on different types of user devices, like laptop 312, tablet 314, or smartphone 316. A user may first receive selected advertisements for comparison displayed on the device 312, 314, 316. Then the user can enter an expanded view 322, 324, 326 of more advertisements relevant to his/her query, e.g. by clicking on a “show more” button on the screen of the device.

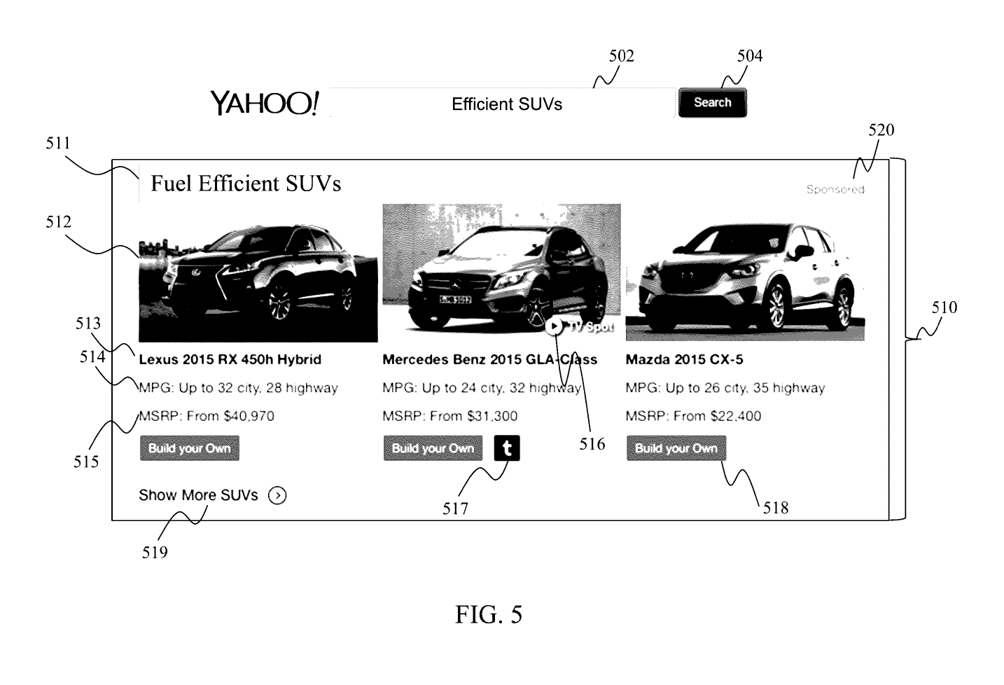

FIG. 5 illustrates a comparison of advertisements relevant to a query, according to an embodiment of the present teaching. As shown in FIG. 5, after a user enters a query “efficient SUVs” in a search box 502 and clicks the search button 504, the system provides a search result 510 including three SUV advertisements for comparison.

In this example, the search result 510 includes an interpreted query 511. An interpreted query may be the same as the query entered in the search box, or may be a different query that can interpret the user's intent based on the query entered in the search box. In this case, the interpreted query 511 is “fuel efficient SUVs,” an interpretation of the query “efficient SUVs” entered in the search box 502. The interpretation may be based on the user's profile, the user's previous online behavior, or popular search queries submitted by all users. A purpose of the interpretation may be to disambiguate the entered query “efficient SUVs,” by interpreting the term “efficient” as “fuel efficient” which is an interesting topic to most users who are interested in SUVs.

Based on the query, the system may select three advertised SUVs with good fuel efficiency for display in the search result 510. In one embodiment, the system may first determine an attribute of the SUV that is relevant to the query, e.g. attribute mileage per gallon (MPG) is relevant to the query “efficient SUVs.” Then, the system may select three advertised SUVs with high MPG values from ad databases. When there are more than three SUVs having high MPG values, the system can select the three based on bid prices during a pre-performed bidding process among the advertisers.

The search result 510 may include a product image 512 for each advertisement. The product image 512 in this example is a picture of SUV corresponding to an advertisement. For each advertisement, the search result 510 also includes attributes associated with the advertised product, i.e. the SUV in this example. The attributes may include the title 513 of the SUV, e.g. Lexus 2015 RX 450h Hybrid. The attributes may also include the MPG 514 of the SUV, e.g. up to 26 city, 35 highway for the Mazda. The attributes may also include the manufacturer's suggested retail price (MSRP) 515 of the SUV, e.g. from $40,970 for the Lexus.

In addition to the attributes, the search result 510 may also include one or more annotations or ad accessories associated with the advertisements. For example, the search result 510 may include a “TV spot” icon 516 associated with the Mercedes Benz SUV, such that if a user clicks the icon 516 or hovers over the image under the icon 516, the system can play a video, e.g. a commercial, related to the Mercedes Benz SUV. The search result 510 may also include a Tumblr logo 517 associated with a product, such that if a user clicks the Tumblr logo 517, the system can direct the user to the social network Tumblr where information about the product is presented. The search result 510 may also include a “build your own” icon 518 associated with an advertised product, such that if a user clicks the “build your own” icon 518, the system can direct the user to a web page where the user can build some of the elements within the product. For example, after a user clicks the “build your own” icon 518 under Mazda, the user is directed to a page where the user can pick the color of the Mazda SUV, the type of engine, the type of tire, etc. It can be understood that in other categories of products, the “build your own” icon 518 may enable the user to build own smartphone, pizza, cable TV package, etc. The “Sponsored” icon 520 shown in FIG. 5 may indicate these are advertisements relevant to the query. It can be understood that the search result 510 may also include hyperlinks directed to documents and/or news relevant to the query, in addition to the advertisements.

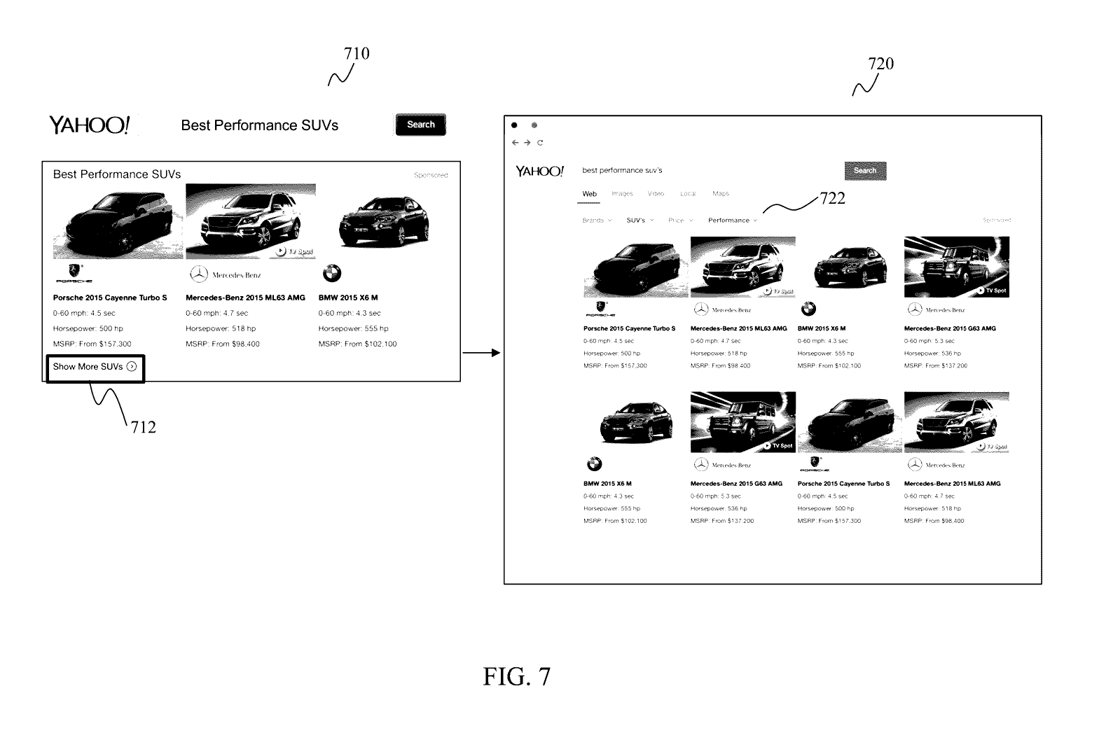

The search result 510 may include a “Show More SUVs” icon or arrow 519, such that if the user wants to view more SUVs than the three listed in the search result 510, the user may click the icon 519 to have an expanded view of more advertised fuel efficient SUVs. FIG. 7 illustrates a comparison of advertisements in an expanded view, according to an embodiment of the present teaching. As shown in FIG. 7, after a user compares three advertised SUVs shown in an original page 710 having a compact view of the SUVs, the user may want to view more relevant SUVs for comparison. In that case, the user may click the “Show More SUVs” icon 712 that can direct the user to a new page 720 having an expanded view of more SUVs. In accordance with one embodiment, the page 720 may include one or more metrics 722 related to the advertised SUVs for the user to select, sort, or filter the SUVs. For example, the user may filter the advertised SUVs by specifying a brand or a price range to limit a scope of the SUVs for comparison.

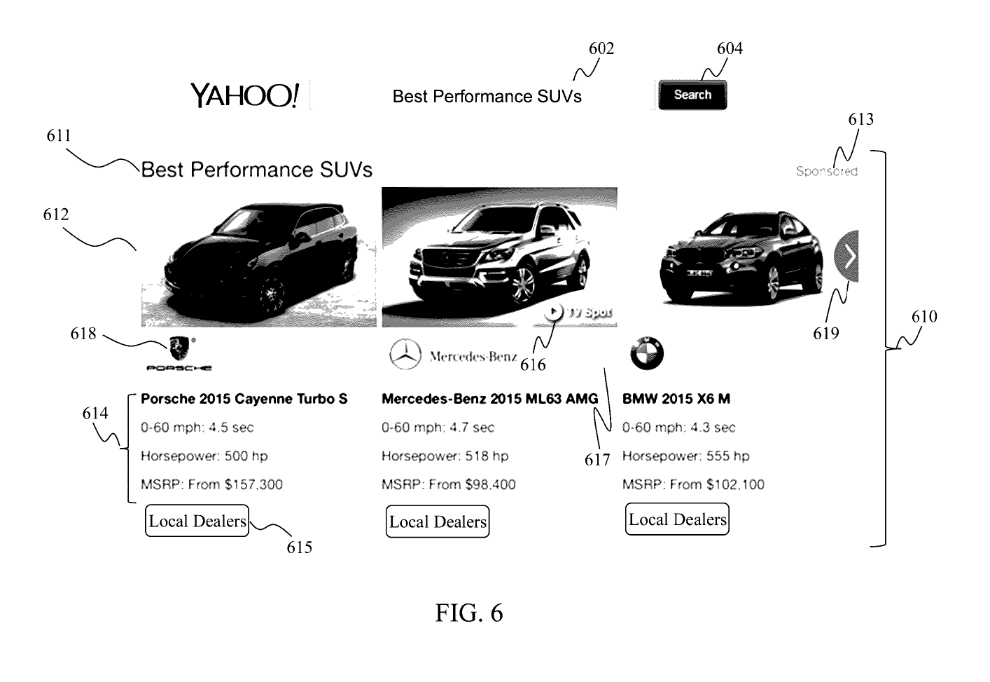

FIG. 6 illustrates a comparison of advertisements relevant to another query, according to an embodiment of the present teaching. As shown in FIG. 6, after a user enters a query “Best Performance SUVs” in a search box 602 and clicks the search button 604, the system provides a search result 610 including three SUV advertisements for comparison.

In this example, the search result 610 includes an interpreted query 611, which is the same as the query “Best Performance SUVs” entered in the search box 602. This may be because the entered query does not have ambiguity itself and has a corresponding ad category stored in an ad database. For example, the “Best Performance SUVs” query may match the SUV category.

Based on the query, the system may select three SUVs with best performance for display in the search result 610. In one embodiment, the system may first determine one or more attributes of the SUV that are relevant to the query, e.g. attributes 0-60 mph and horsepower are relevant to the query “best performance SUVs.” Then, the system may select three advertised SUVs with good attribute values, which means short time for 0-60 mph and high horsepower value in this example, from ad databases. When there are more than three SUVs having good attribute values, the system can select the three based on bid prices during a pre-performed bidding process among the advertisers.

The query in FIG. 6 is different from the query in FIG. 5. Although a same category “SUV” is determined based on both queries, the system determines different attributes based on the query in FIG. 6, compared to FIG. 5. Accordingly, the SUVs selected in FIG. 6 are also different from those in FIG. 5. Thus, the attributes and the advertised products can dynamically change according to different queries directed to a same category, such that the user can have an immediate comparison of the advertised products in accordance with the user's specific intent and need. In one embodiment, a different query may trigger same attributes listed according to a different order.

The search result 610 may include a product image 612 for each advertisement. For each advertisement, the search result 610 may also include attributes 614 associated with the advertised product, i.e. the SUV in this example. The attributes may include the title of the SUV, the 0-60 mph time, the horsepower, and the MSRP. The attributes shown in FIG. 6 are different from the attributes shown in FIG. 5, because the two users' needs are different, one for fuel efficiency and the other for best performance.

In addition to the attributes, the search result 610 may also include one or more annotations or ad accessories associated with the advertisements. For example, the search result 610 may include a “TV spot” icon 616 associated with the Mercedes-Benz SUV, such that if a user clicks the icon 616 or hovers over the image under the icon 616, the system can play a video, e.g. a commercial, related to the Mercedes-Benz SUV. The search result 610 may also include a Tumblr logo 617 associated with a product, such that if a user clicks the Tumblr logo 617, the system can direct the user to the social network Tumblr where information about the product is presented. The system may select an advertised product to assign an annotation, e.g. the “TV spot” or Tumblr logo, based on a bid price during a pre-performed bidding process from the corresponding advertiser.

The search result 610 may also include a brand logo 618 for each advertised product. The search result 610 may also include a “Local Dealers” icon 615 associated with an advertised product, such that if a user clicks the “Local Dealers” icon 615, the system can direct the user to web pages of local dealers where the advertised SUV is being sold. For example, after a user clicks the “Local Dealers” icon 615 under Porsche, the user may be provided a list of local Porsche dealers. After the user selects one of them, the user is directed to a web page of the selected dealer. In another example, after a user clicks the “Local Dealers” icon 615 under Porsche, the user may be provided a list of phone numbers of local Porsche dealers, such that after the user selects one of them on his/her smartphone, a phone call is automatically dialed to the selected dealer. The location information of the user can be detected via the user's device, e.g. by the device's Internet Protocol (IP) address or a global positioning system (GPS) function implemented on the device. In one embodiment, the system can also utilize the user's location information to further analyze the query, and to select the advertisements, the category, and/or the attributes.

The “Sponsored” icon 613 shown in FIG. 6 may indicate these are advertisements relevant to the query. It can be understood that the search result 610 may also include hyperlinks directed to documents and/or news relevant to the query, in addition to the advertisements.

The search result 610 may include an arrow 619, such that the advertisements are displayed in a carousel style. For example, if the user wants to view more SUVs than the three listed in the search result 610, the user may click the arrow 619 to view three more SUVs with best performance replacing the current three in FIG. 6. It can be understood that the arrow 619 can be replaced with another annotation having a similar functionality, e.g. a slide-on function on a touch screen device such that the user can just slide the screen to the right to view more SUVs.

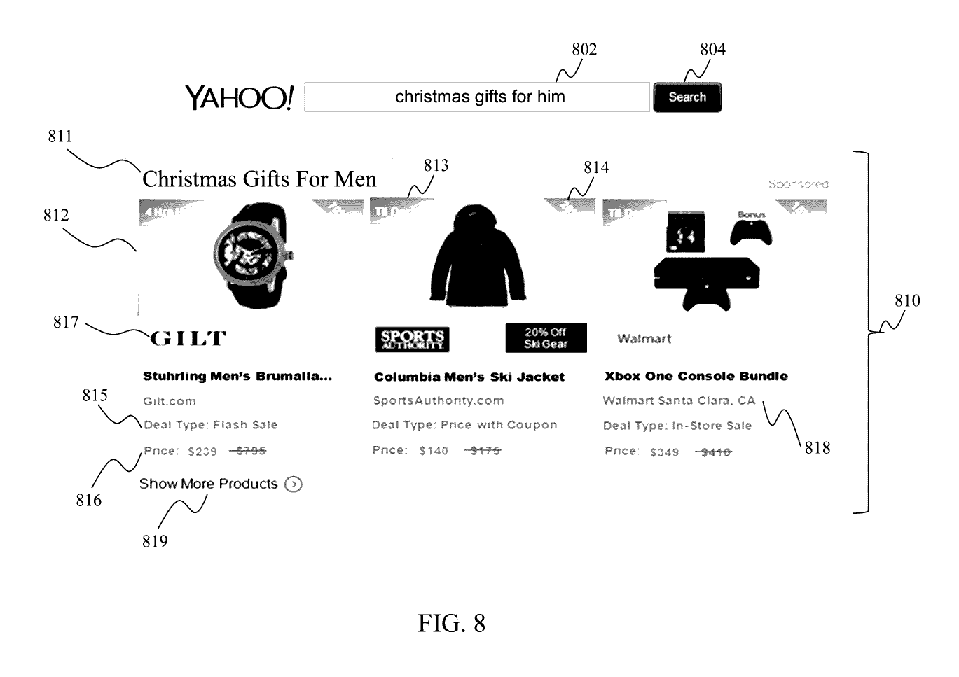

FIG. 8 illustrates a comparison of advertisements relevant to a different user query, according to an embodiment of the present teaching. As shown in FIG. 8, after a user enters a query “Christmas gifts for him” in a search box 802 and clicks the search button 804, the system provides a search result 810 including three advertised gifts for comparison.

In this example, the search result 810 includes an interpreted query “Christmas gifts for men” 811, which is an interpretation of the query “Christmas gifts for him” entered in the search box 802. This may be based on parsing the query and analyzing semantic meaning of the parsed terms to interpret the user's intent and need. For example, without more specific information about “him,” the system interprets “him” as a general male person, and therefore generates the interpreted query “Christmas gifts for men” 811. In one scenario, the system may determine that “him” in the query means a specific person, e.g. the user's husband, based on the user's previous online behavior, like online posting in a social network about buying her husband a Christmas gift. In that case, the system may generate another interpreted query like “Christmas gifts for XXX” where XXX represents her husband's name. In one embodiment, the user has an option to change the interpreted query.

Based on the query, the system may select three advertised Christmas gifts designed for men to be presented in the search result 810. In one embodiment, the system may first determine one or more attributes of the gifts that are relevant to the query, e.g. attributes of prices and deal types are relevant to the query “Christmas gifts for men.” Then, the system may select three advertised gifts with good attribute values, e.g. a gift with a deal or discount is better than another gift without a deal or discount, from ad databases. In one example, the selection may also be based on popularity of the gifts and/or local availability of the gifts. As shown in FIG. 8, if the system detects that the user is located around Santa Clara, Calif., the system may select the Xbox, which is available as a Christmas gift for men in a Walmart store at Santa Clara, Calif., to be presented in the search result 810. The system can also select the three gifts based on bid prices during a pre-performed bidding process among the advertisers.

The search result 810 may include a product image 812 for each advertisement. The image 812 may include information about a deal or discount associated with the gift. For example, the image 812 may include a discount percentage 814 and a time limit 813 for the discount.

For each advertisement, the search result 810 may also include attributes associated with the advertised product. The attributes may include the gift's title, the gift's online or local location 818, the gift's deal type 815, and the gift's prices before and after discount 816.

In addition to the attributes, the search result 810 may also include one or more annotations or ad accessories associated with the advertisements. For example, the search result 810 may include a store logo 817 of an online or local store that carries the advertised product.

The search result 810 may include a “Show More Products” icon or arrow 819, such that if the user wants to view more Christmas gifts for men than the three listed in the search result 810, the user may click the icon 819 to have an expanded view of more advertised gifts. In contrast to FIG. 5 and FIG. 6 where advertisers of the advertisements are manufacturers, the advertisers of the advertisements in FIG. 8 are retailers.

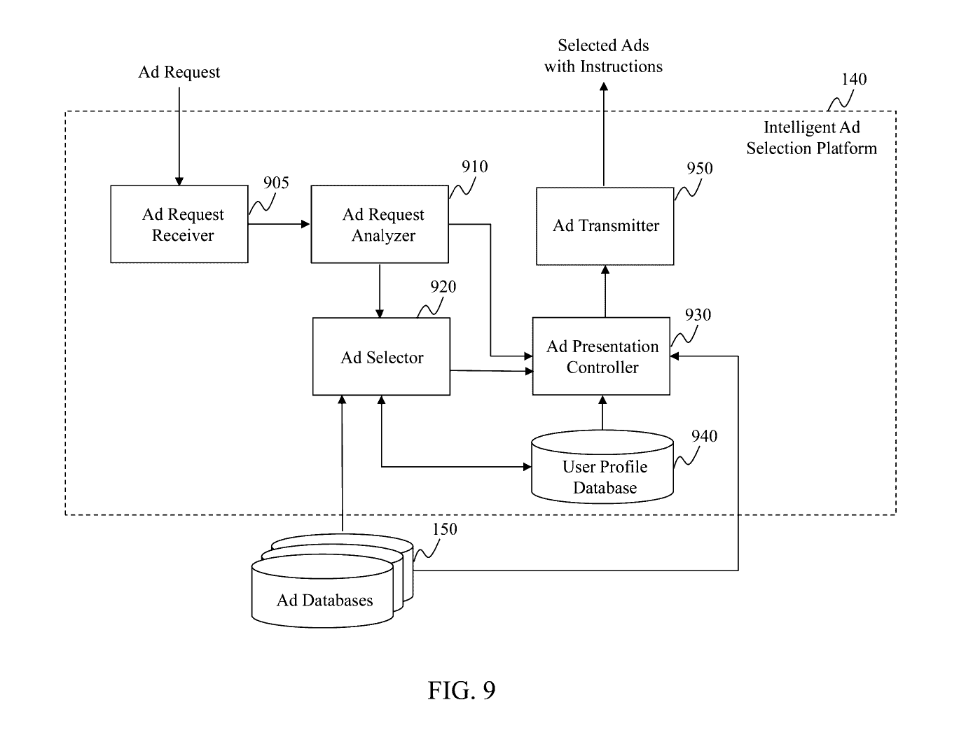

FIG. 9 illustrates an exemplary diagram of an intelligent ad selection platform 140, according to an embodiment of the present teaching. The intelligent ad selection platform 140 in this example includes an ad request receiver 905, an ad request analyzer 910, an ad selector 920, an ad presentation controller 930, a user profile database 940, and an ad transmitter 950.

The ad request receiver 905 in this example receives an ad request, either from a search engine or directly from a user. The ad request may incorporate a query for advertisements. In one embodiment, the user submits a query about a category of product to the search engine and the search engine generates and sends the ad request to the intelligent ad selection platform 140 for advertisements related to the product category. The ad request receiver 905 may receive the ad request and forward it to the ad request analyzer 910 for analysis.

The ad request analyzer 910 in this example analyzes the request and extracts information from the request. The extracted information may include a query submitted by the user together with a user identity (ID) associated with the user. In one embodiment, the request is from a service provider that provides the user a web page. Then the extracted information may include content ID associated with content on the web page where the user browses or enters a search query. The ad request analyzer 910 may send the extracted information to the ad selector 920 for selecting advertisements and to the ad presentation controller 930 for generating an instruction for presenting the advertisements.

The ad selector 920 in this example may determine the user's demographic information, location information, and/or device information based on the user ID, e.g. by retrieving a user profile of the user from the user profile database 940. The ad selector 920 may determine a category of product based on the determined user information together with the query and/or the content information associated with the content ID. For example, a category may be travel, autos, gifts, or a more specific one like cruises, flights, SUV. This category can be referred as ad category because each category is associated with a group of advertisements.

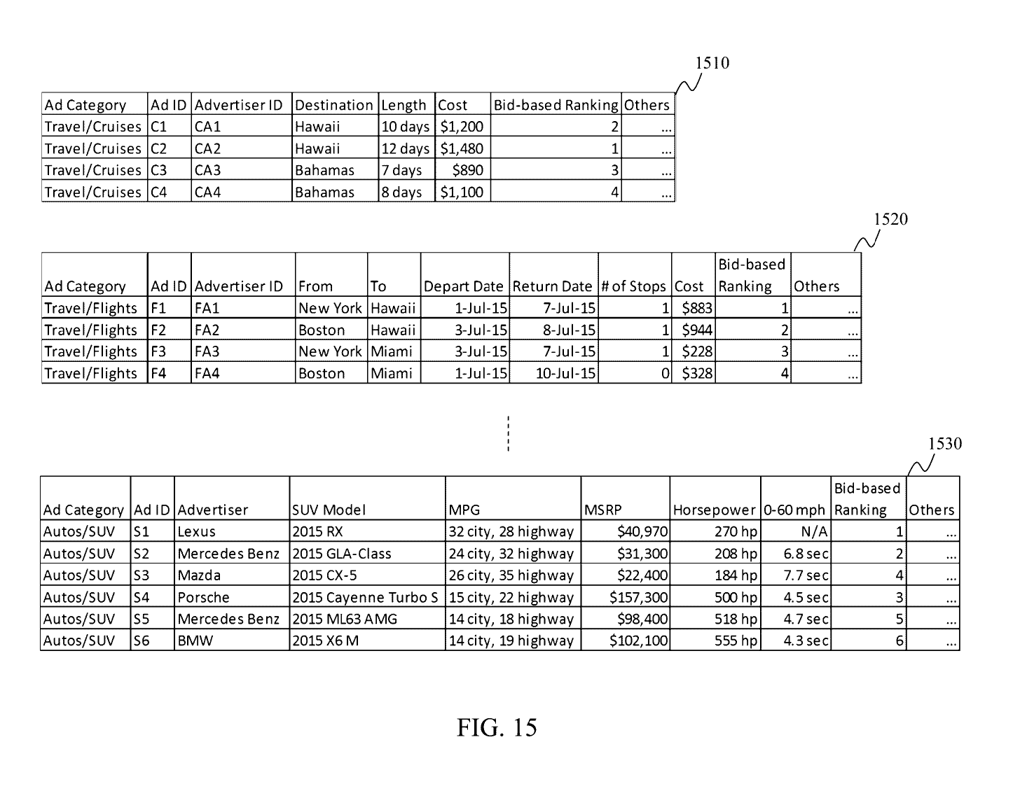

As discussed above, each category may be associated with different attributes. FIG. 15 illustrates tables of different ad categories, according to an embodiment of the present teaching. As shown in FIG. 15, a cruise category in table 1510 may be associated with attributes like destination, length, cost; while an SUV category in table 1530 may be associated with attributes like SUV model, MPG, MSRP, horsepower, 0-60 mph.

Depending on the query and the category, the ad selector 920 may select one or more attributes for the category. For example, if the category is determined to be SUV based on a query “fuel efficient SUV,” the ad selector 920 may select the attribute MPG instead of the attribute horsepower from the table 1530, because the query indicates that the user is more interested in the MPG value instead of the horsepower value. According to other embodiments, the ad selector 920 may determine the category and/or the attribute(s) based on the user's location, device, demographic or behavior information.

Based on the determined category and attribute(s), the ad selector 920 may select one or more advertisements for presentation to the user. In one embodiment, the selection can be based on the attribute values of the advertised products under the determined category. In another embodiment, the selection may also be based on the advertisements' rankings determined during a bidding process performed before. The ad selector 920 can retrieve the selected advertisements from the one or more ad databases 150 and send the advertisements to the ad presentation controller 930 for generating an instruction for presenting the advertisements.

The ad presentation controller 930 in this example can receive the user's information (demographic information, location information, and/or device information) from the ad request analyzer 910 or retrieve the user's information from the user profile database 940 based on the user ID received from the ad request analyzer 910. The ad presentation controller 930 may receive advertisements selected and retrieved by the ad selector 920 or retrieve the advertisements directly from the ad databases 150. Based on the user's information and/or the advertisements, the ad presentation controller 930 may determine annotations or ad accessories for the advertisements. As discussed above, the annotations may include a brand logo, a discount icon, a video related to the advertised product, or a hyperlink directed to a local store or local dealer for the user. In an embodiment, the ad presentation controller 930 may select different annotations for different advertisements based on their rankings determined during a bidding process performed before. The ad presentation controller 930 can retrieve the annotations or ad accessories from the ad databases 150 and generate an instruction on presentation of the advertisements, the attributes, and the annotations. The instruction may indicate how to present the advertisements, with the attributes and the annotations.

The user profile database 940 in this example can transmit information related to the instruction, the advertisements, the attributes, and the annotations to the user or to the search engine, in response to the ad request.

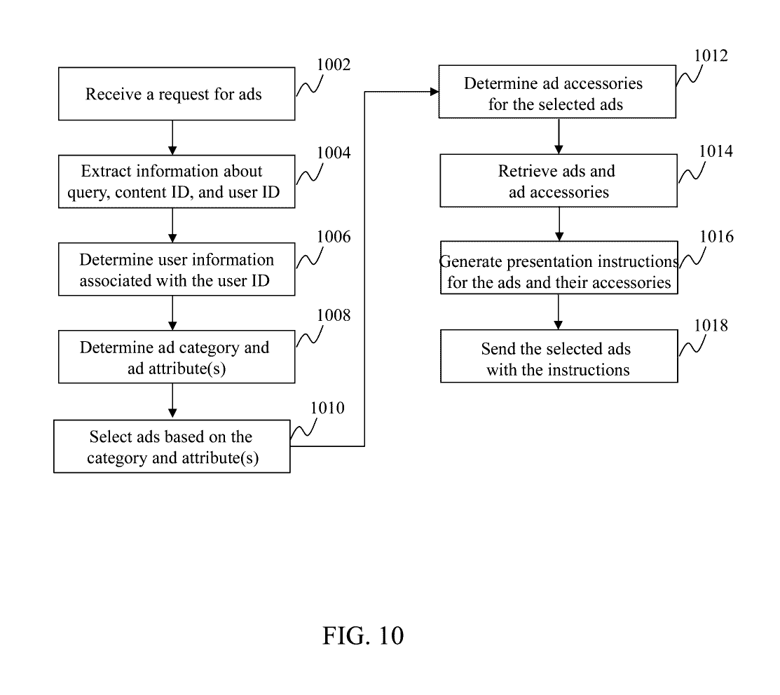

FIG. 10 is a flowchart of an exemplary process performed by an intelligent ad selection platform, e.g. the intelligent ad selection platform 140 in FIG. 9, according to an embodiment of the present teaching. At 1002, a request for advertisements is received, either from a search engine or directly from a user. At 1004, information is extracted from the request, where the information may include a query, a content ID, and/or a user ID associated with the user. User information of the user is determined at 1006, based on the user ID. At 1008, ad category and ad attribute(s) are determined, based on the user information, the query, or the content ID.

At 1010, one or more advertisements are determined or selected based on the category and the attribute(s). Ad accessories or annotations are determined at 1012 for the selected advertisements. At 1014, the advertisements and the annotations are retrieved. Then, a presentation instruction may be generated at 1016 for the advertisements and their accessories or annotations. At 1018, the selected advertisements are sent with the instructions.

It can be understood that the order of the steps shown in FIG. 10 may be modified according to different embodiments. For example, advertisements retrieved at step 1014 may also be retrieved before step 1012.

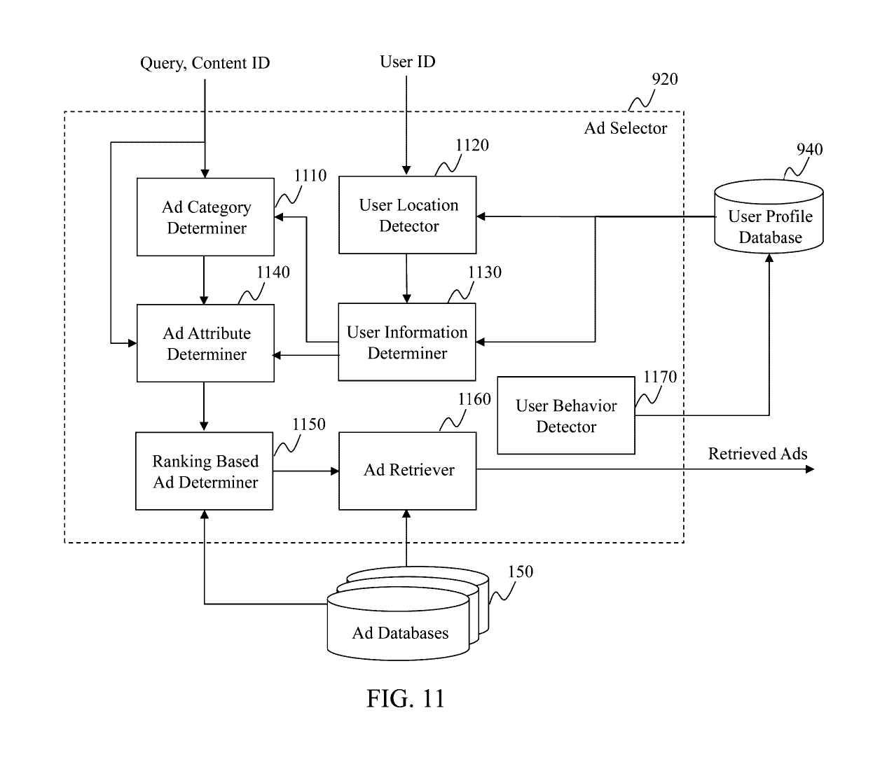

FIG. 11 illustrates an exemplary diagram of an ad selector 920, according to an embodiment of the present teaching. In this example, the ad selector 920 includes an ad category determiner 1110, a user location detector 1120, a user information determiner 1130, an ad attribute determiner 1140, a ranking based ad determiner 1150, an ad retriever 1160, and a user behavior detector 1170.

The ad category determiner 1110 in this example can receive information about the query submitted by the user and/or the content ID of the content browsed by the user. The ad category determiner 1110 can determine an ad category based on the query or the content ID. In one embodiment, the ad category determiner 1110 can match the query to an ad category listed in tables shown in FIG. 15. In another embodiment, the ad category determiner 1110 can determine an ad category based on the content ID that is associated with an ad category (not shown in FIG. 15). In yet another embodiment, the ad category determiner 1110 may determine an ad category based on user information associated with the user.

The user location detector 1120 in this example may receive information about a user ID of the user. Based on the user ID, the user location detector 1120 can retrieve a user profile of the user from the user profile database 940 and detect the user's location associated with the user ID. The detection may be based on an IP address of the user's device or a GPS function implemented on the user's device.

The user information determiner 1130 in this example can determine user information of the user based on the user ID. In one embodiment, the user information determiner 1130 may determine the user's demographic information and behavior information based on the user profile retrieved from the user profile database 940. In another embodiment, the user information determiner 1130 may determine the user's location or device information based on the user profile retrieved from the user profile database 940 or from information forwarded by the user location detector 1120. The user information determiner 1130 can send the user information to the ad category determiner 1110 for determining the product category or to the ad attribute determiner 1140 for determining ad attributes.

The ad attribute determiner 1140 in this example may determine one or more ad attributes associated with the category determined by the ad category determiner 1110. The one or more ad attributes may be selected from all attributes associated with the category, based on the query, the content ID, or the user information. For example, if the query is “cheap flight from Boston,” the category would be travel/flights shown in FIG. 15, and the attributes like “From” “To” and “Cost” may be selected, such that advertisements will be chosen based on the selected attributes. For example, the “From” value should be equal to “Boston” and the “Cost” should be low to satisfy the query. When the advertisements are presented to the user, only the selected attributes are presented together to the user. The order of the presentation may also be based on the query, as discussed below.

The ranking based ad determiner 1150 in this example can determine the advertisements for presentation to the user, in accordance with the determined category and attribute(s). For example, when the query is “cheap SUV,” the category would be Autos/SUV as shown in table 1530 of FIG. 15, and the determined attributes may include MSRP and MPG. In this example, the ranking based ad determiner 1150 may rank the advertised SUVs according to the attributes (e.g. MSRP) and select advertisements of advertised SUVs having a low MSRP, e.g. lower than $100,000. Then, the ranking based ad determiner 1150 can select advertisements S1, S2, S3, S5, shown in table 1530 of FIG. 15. In one embodiment, if the presentation requires selecting top three advertisements, the ranking based ad determiner 1150 can remove the S5 based on its highest MSRP among the four. In another embodiment, if the presentation requires selecting top two advertisements, the ranking based ad determiner 1150 can select S1 and S2 based on their highest bid-based rankings among the four, although S3 has a lower MSRP. The bid-based rankings may be pre-determined based on a bidding process performed among the advertisers of the advertisements. The ad retriever 1160 in this example can retrieve the determined advertisements from the ad databases 150 and send to the ad presentation controller 930 for generating a presentation instruction.

The user behavior detector 1170 in this example can detect user behavior information of users who submit a query and/or receive advertisements for comparison. The user behavior detector 1170 can analyze the user behavior information and update the user profiles of the users in the user profile database 940.

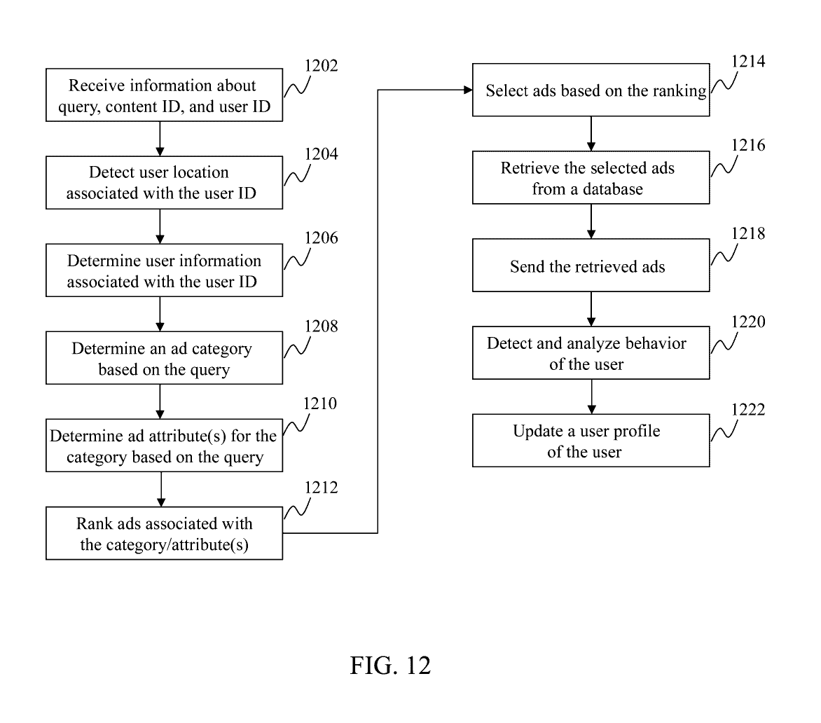

FIG. 12 is a flowchart of an exemplary process performed by an ad selector, e.g. the ad selector 920 in FIG. 11, according to an embodiment of the present teaching. At 1202, information about a query, a content ID, and/or a user ID associated with a user submitting the query is received. User location associated with the user ID is detected at 1204. At 1206, user information associated with the user ID is determined. An ad category is determined 1208 based on the query. One or more ad attributes are determined at 1210 for the category based on the user information, the query, or the content ID.

At 1212, advertisements are ranked based on the category and attribute(s), or bid prices from a bidding process according to an embodiment. One or more advertisements are selected at 1214 based on the ranking The selected ads are retrieved at 1216 from a database and sent at 1218 to the ad presentation controller 930. At 1220, behavior information of the user is detected and analyzed. A user profile of the user is updated at 1222, e.g. based on the detected behavior information.

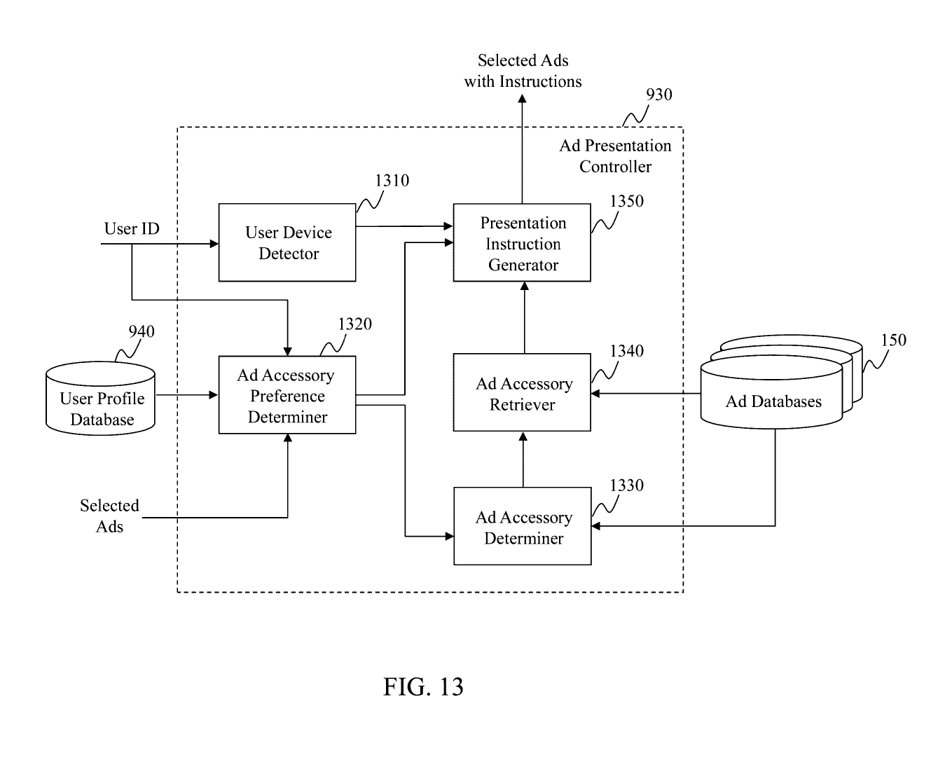

FIG. 13 illustrates an exemplary diagram of an ad presentation controller 930, according to an embodiment of the present teaching. In this example, the ad presentation controller 930 includes a user device detector 1310, an ad accessory preference determiner 1320, an ad accessory retriever 1340, an ad accessory determiner 1330, and a presentation instruction generator 1350.

The user device detector 1310 in this example receives a user ID of the user who submits the query, and detects the user's device being used by the user. The user device detector 1310 may determine information about the user's device, like device type (e.g. laptop, tablet, or smartphone), screen size, operation system (e.g. windows, android, or iOS), web browser (e.g. internet explorer, Firefox, or Chrome), etc. The user device detector 1310 can send the device information to the presentation instruction generator 1350 for generating a presentation instruction for presenting the selected advertisements on the device.

The ad accessory preference determiner 1320 in this example can receive the selected advertisements from the ad selector 920 and the user ID from the ad request analyzer 910. Based on the user ID and the selected advertisements, the ad accessory preference determiner 1320 can determine the user's preference regarding ad accessories. For example, the ad accessory preference determiner 1320 may retrieve the user profile of the user from the user profile database 940, where the user profile includes information about what kind of ad accessories or annotations may promote the user's click through rate of the advertisements in the same category as the selected advertisements. The ad accessory preference determiner 1320 may send the user preference information to the ad accessory determiner 1330 for determining ad accessories to be presented with the selected advertisements. As discussed above, the ad accessories or annotations may include: a brand logo associated with a product in the category determined based on the query; a hyperlink directed to a social network including information about a product in the category; information about sales, discounts, or coupons related to a product in the category; a link directed to a video describing a product in the category; an entry form for a user to enter location information; an icon, once selected by the user, connects the user to a website of a local dealer or a local store; an icon, once selected by the user, activates a phone call to a local dealer or a local store for the user; an icon, once selected by the user, activates presentation of more advertisements associated with the category of product to replace the at least one advertisement; and a link directed to a web page including a plurality of advertisements associated with the category of product, wherein the web page includes one or more metrics related to the plurality of advertisements for the user to select, sort or filter the advertisements. The ad accessory preference determiner 1320 may forward the selected advertisements to the ad accessory determiner 1330 and the presentation instruction generator 1350.

The ad accessory determiner 1330 in this example can determine ad accessories to be presented with the selected advertisements. In one embodiment, the determination may be based on the user preference information received from the ad accessory preference determiner 1320. For example, if a user is determined to prefer hyperlinks to social network where user reviews or comments about the advertised product can be found, the ad accessory determiner 1330 can determine to put these hyperlinks in association with the selected advertisements during presentation. In another embodiment, the determination may be based on bid prices from the advertisers of the selected advertisements. For example, if among three advertisers of three selected advertisements, one advertiser offered a highest bid price, the ad accessory determiner 1330 can determine to put a link to a video commercial of the advertiser's product in association with the product during presentation. It can be understood that, in some embodiments, the selected advertisements are with respect to different products from same advertiser, e.g. different phone plans from a same wireless carrier.

The ad accessory retriever 1340 in this example can retrieve the ad accessories from the ad databases 150 based on the information about the determined ad accessories from the ad accessory determiner 1330. The ad accessory retriever 1340 can send the retrieved ad accessories to the presentation instruction generator 1350 for generating a presentation instruction.

The presentation instruction generator 1350 in this example generates a presentation instruction on presentation of the selected advertisements, based on the selected advertisements from the ad accessory preference determiner 1320, the user device information from the user device detector 1310, and/or the ad accessories from the ad accessory retriever 1340. The instruction may indicate how to present the selected advertisements, e.g. whether in a compact view, an expanded view, or a carousel view; advertisement location in the web page; background color; font size; how to present the ad accessories; how to present the attribute(s), etc. The instruction may indicate to emphasize on some key attributes. For example, in response to the query “cheap SUV,” although both MPG and MSRP are presented, the MSRP value may be emphasized, e.g. with bold font or underline. The presentation instruction generator 1350 can send information about the selected advertisements (including the selected ad accessories, attributes, etc.) with the instruction to the ad transmitter 950. A search engine or publisher may use the instruction to provide the advertisements to the user.

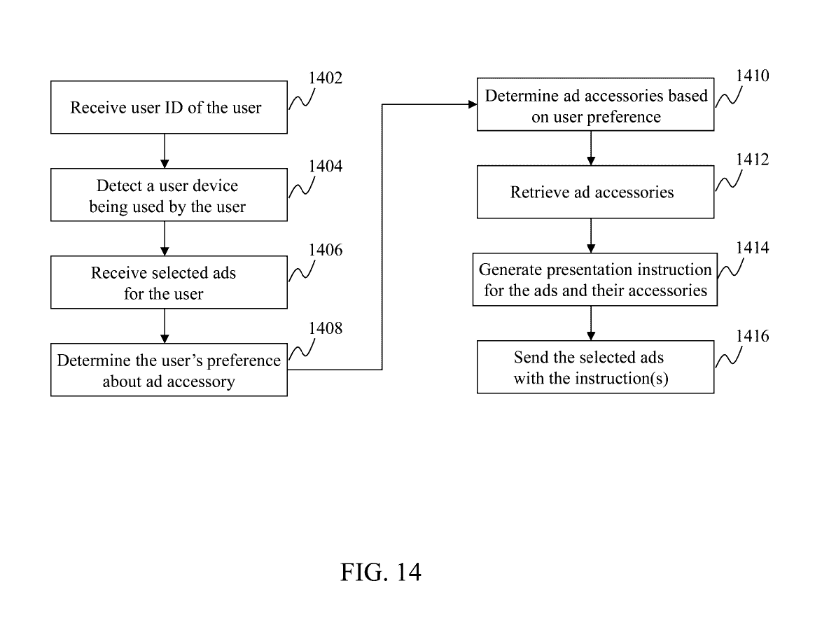

FIG. 14 is a flowchart of an exemplary process performed by an ad presentation controller, e.g. the ad presentation controller 930 in FIG. 13, according to an embodiment of the present teaching. At 1402, a user ID of the user who submits the query or browses a web page having advertisement opportunities is received. Information about a user device being used by the user is detected at 1404. Selected advertisements for the user are received at 1406.

At 1408, the user's preferences regarding ad accessories are determined, e.g. based on a user profile associated with the user. At 1410, advertisement accessories are determined based on the user preference and/or other factors like bid prices of the advertisers of the selected advertisements. The ad accessories or annotations for the selected advertisements are retrieved at 1412. One or more presentation instructions are generated at 1414 for presenting the selected advertisements, including their accessories and attributes. At 1416, the instruction(s) are sent with the selected advertisements, including their accessories and attributes.

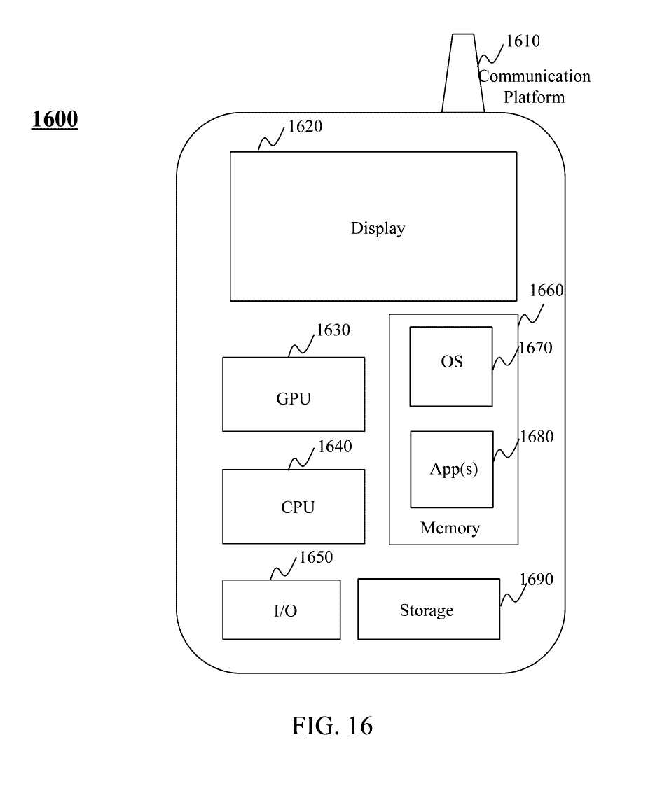

FIG. 16 depicts the architecture of a mobile device which can be used to realize a specialized system implementing the present teaching. In this example, the user device on which advertisements are presented and interacted-with is a mobile device 1600, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1600 in this example includes one or more central processing units (CPUs) 1640, one or more graphic processing units (GPUs) 1630, a display 1620, a memory 1660, a communication platform 1610, such as a wireless communication module, storage 1690, and one or more input/output (I/O) devices 1650. Any other suitable component, including but not limited to a system bus or a controller (not shown), may also be included in the mobile device 1600. As shown in FIG. 16, a mobile operating system 1670, e.g., iOS, Android, Windows Phone, etc., and one or more applications 1680 may be loaded into the memory 1660 from the storage 1690 in order to be executed by the CPU 1640. The applications 1680 may include a browser or any other suitable mobile apps for receiving advertisements on the mobile device 1600. User interactions with the advertisements or other content items may be achieved via the I/O devices 1650 and provided to the intelligent ad selection platform 140 and/or other components of systems 100 and 200, e.g., via the network 120.

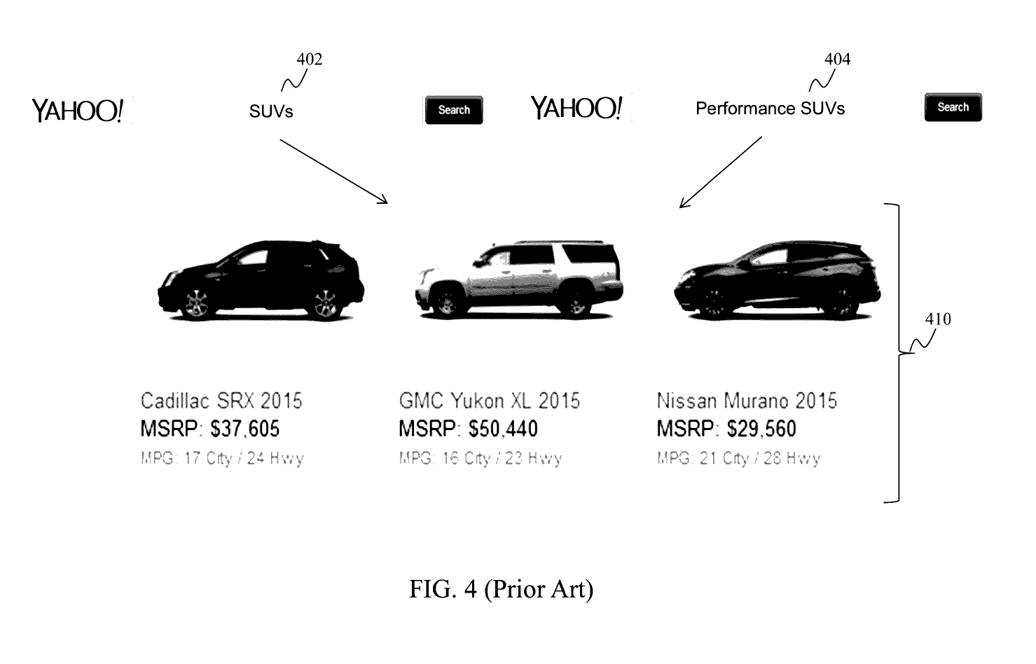

To implement various modules, units, and their functionalities described in the present disclosure, computer hardware platforms may be used as the hardware platform(s) for one or more of the elements described herein (e.g., the intelligent ad selection platform 140 and/or other components of systems 100 and 200 described with respect to FIGS. 1-15). The hardware elements, operating systems and programming languages of such computers are conventional in nature, and it is presumed that those skilled in the art are adequately familiar therewith to adapt those technologies to selecting and providing an advertisement to a user as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

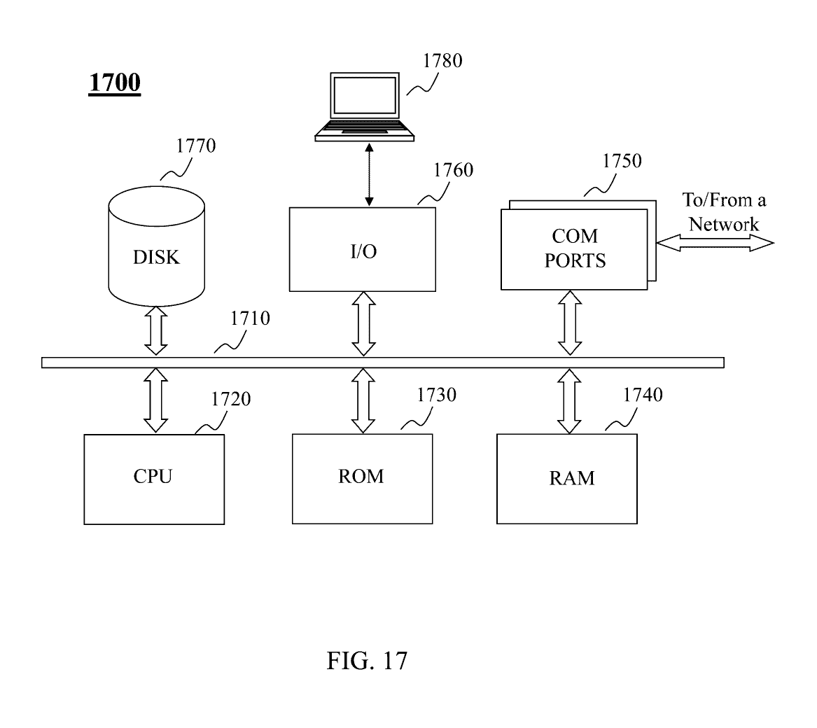

FIG. 17 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1700 may be used to implement any component of the dynamic advertisement selection techniques, as described herein. For example, the intelligent ad selection platform 140, etc., may be implemented on a computer such as computer 1700, via its hardware, software program, firmware, or a combination thereof. Although only one such computer is shown, for convenience, the computer functions relating to dynamic advertisement selection as described herein may be implemented in a distributed fashion on a number of similar platforms, to distribute the processing load.

The computer 1700, for example, includes COM ports 1750 connected to and from a network connected thereto to facilitate data communications. The computer 1700 also includes a central processing unit (CPU) 1720, in the form of one or more processors, for executing program instructions. The exemplary computer platform includes an internal communication bus 1710, program storage and data storage of different forms, e.g., disk 1770, read only memory (ROM) 1730, or random access memory (RAM) 1740, for various data files to be processed and/or communicated by the computer, as well as possibly program instructions to be executed by the CPU. The computer 1700 also includes an I/O component 1760, supporting input/output flows between the computer and other components therein such as user interface elements 1780. The computer 1700 may also receive programming and data via network communications.

Hence, aspects of the methods of dynamic advertisement selection, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer into the hardware platform(s) of a computing environment or other system implementing a computing environment or similar functionalities in connection with dynamic advertisement selection. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the dynamic advertisement selection as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method, implemented on a machine having at least one processor, storage, and a communication platform connected to a network for providing advertisement, the method comprising:
receiving a request for selecting advertisement, wherein the request incorporates a query;
analyzing the query to determine a category of product and determine one or more attributes of the category of product based on the query;
selecting at least one advertisement associated with the category of product based on the one or more attributes and the request;
generating an instruction on presentation of the at least one advertisement in accordance with the one or more attributes; and
sending information related to the instruction and the at least one advertisement as a response to the request.

2. The method of claim 1, further comprising:
receiving an additional request for selecting advertisement, wherein the additional request incorporates an additional query;
analyzing the additional query to determine the category of product; and
determining one or more different attributes of the category of product based on the additional query.

3. The method of claim 1, further comprising:
receiving an additional request for selecting advertisement, wherein the additional request incorporates an additional query;
analyzing the additional query to determine the category of product; and
determining the one or more attributes of the category of product based on the additional query, wherein the one or more attributes are to be presented as a response to the additional request according to a different order than those to be presented as a response to the request.

4. The method of claim 1, wherein analyzing the query comprises:
parsing the query into at least a first portion and a second portion;
determining the category of product based on the first portion; and
determining the one or more attributes of the category of product based on the second portion.

5. The method of claim 4, wherein determining the one or more attributes comprises:
identifying a plurality of attributes associated with the category of product; and
selecting the one or more attributes from the plurality of attributes based on the second portion of the query.

6. The method of claim 1, wherein analyzing the query comprises:
converting the query into a second query; and
determining the category of product and the one or more attributes of the category of product based on the second query.

7. The method of claim 1, wherein the query is received from a user and the one or more attributes of the category of product are determined based on the user's location.

8. The method of claim 1, wherein the query is received from a user and the instruction on presentation of the at least one advertisement is generated based on the user's device on which the at least one advertisement is to be presented.

9. The method of claim 1, wherein selecting the at least one advertisement comprises:
determining a plurality of advertisements associated with the category of product based on the one or more attributes and the request;
ranking the plurality of advertisements based on a bidding process with respect to the category of product; and
selecting the at least one advertisement from the plurality of advertisements based on the ranking

10. The method of claim 1, wherein the instruction indicates that the at least one advertisement is to be presented with one or more annotations associated with the at least one advertisement.

11. The method of claim 10, wherein the query is received from a user and the one or more annotations are determined based on information related to at least one of the following:
the user's location;
the user's device;
the user's demographic information; and
the user's behavior information.

12. The method of claim 10, wherein the one or more annotations include at least one of the following:
a brand logo associated with a product in the category;
a hyperlink directed to a social network including information about a product in the category;
information about sales, discounts, or coupons related to a product in the category;
a link directed to a video describing a product in the category;
an entry form for a user to enter location information;
an icon, once selected by the user, connects the user to a website of a local dealer or a local store;
an icon, once selected by the user, activates a phone call to a local dealer or a local store for the user;
an icon, once selected by the user, activates presentation of more advertisements associated with the category of product to replace the at least one advertisement; and
a link directed to a web page including a plurality of advertisements associated with the category of product, wherein the web page includes one or more metrics related to the plurality of advertisements for the user to select, sort or filter the advertisements.

13. A system having at least one processor, storage, and a communication platform connected to a network for providing advertisement, the system comprising:
an ad request receiver configured for receiving a request for selecting advertisement, wherein the request incorporates a query;
an ad request analyzer configured for analyzing the query to determine a category of product and determine one or more attributes of the category of product based on the query;
an ad selector configured for selecting at least one advertisement associated with the category of product based on the one or more attributes and the request;
an ad presentation controller configured for generating an instruction on presentation of the at least one advertisement in accordance with the one or more attributes; and
an ad transmitter configured for sending information related to the instruction and the at least one advertisement as a response to the request.

14. The system of claim 13, wherein:
the ad request receiver is further configured for receiving an additional request for selecting advertisement, wherein the additional request incorporates an additional query; and
the ad request analyzer is further configured for analyzing the additional query to determine the category of product and determine one or more different attributes of the category of product based on the additional query.

15. The system of claim 13, further comprising:
the ad request receiver is further configured for receiving an additional request for selecting advertisement, wherein the additional request incorporates an additional query; and
the ad request analyzer is further configured for analyzing the additional query to determine the category of product and determine the one or more attributes of the category of product based on the additional query, wherein the one or more attributes are to be presented as a response to the additional request according to a different order than those to be presented as a response to the request.

16. The system of claim 13, wherein analyzing the query comprises:
parsing the query into at least a first portion and a second portion;
determining the category of product based on the first portion; and
determining the one or more attributes of the category of product based on the second portion.

17. The system of claim 16, wherein determining the one or more attributes comprises:
identifying a plurality of attributes associated with the category of product; and
selecting the one or more attributes from the plurality of attributes based on the second portion of the query.

18. The system of claim 13, wherein analyzing the query comprises:
converting the query into a second query; and
determining the category of product and the one or more attributes of the category of product based on the second query.

19. The system of claim 13, wherein the query is received from a user and the one or more attributes of the category of product are determined based on the user's location.

20. The system of claim 13, wherein the query is received from a user and the instruction on presentation of the at least one advertisement is generated based on the user's device on which the at least one advertisement is to be presented.

21. The system of claim 13, wherein selecting the at least one advertisement comprises:
determining a plurality of advertisements associated with the category of product based on the one or more attributes and the request;
ranking the plurality of advertisements based on a bidding process with respect to the category of product; and
selecting the at least one advertisement from the plurality of advertisements based on the ranking

22. The system of claim 13, wherein the instruction indicates that the at least one advertisement is to be presented with one or more annotations associated with the at least one advertisement.

23. The system of claim 22, wherein the query is received from a user and the one or more annotations are determined based on information related to at least one of the following:
the user's location;
the user's device;
the user's demographic information; and
the user's behavior information.

24. The system of claim 22, wherein the one or more annotations include at least one of the following:
a brand logo associated with a product in the category;
a hyperlink directed to a social network including information about a product in the category;
information about sales, discounts, or coupons related to a product in the category;
a link directed to a video describing a product in the category;
an entry form for a user to enter location information;
an icon, once selected by the user, connects the user to a website of a local dealer or a local store;
an icon, once selected by the user, activates a phone call to a local dealer or a local store for the user;
an icon, once selected by the user, activates presentation of more advertisements associated with the category of product to replace the at least one advertisement; and
a link directed to a web page including a plurality of advertisements associated with the category of product, wherein the web page includes one or more metrics related to the plurality of advertisements for the user to select, sort or filter the advertisements.

25. A machine-readable, non-transitory and tangible medium having information recorded thereon for providing advertisement, the information, when read by the machine, causes the machine to perform the following:
receiving a request for selecting advertisement, wherein the request incorporates a query;
analyzing the query to determine a category of product and determine one or more attributes of the category of product based on the query;
selecting at least one advertisement associated with the category of product based on the one or more attributes and the request;
generating an instruction on presentation of the at least one advertisement in accordance with the one or more attributes; and
sending information related to the instruction and the at least one advertisement as a response to the request.
